(19) United States
(12) Patent Application Publication
(10) Pub. No.: US 2009/0284977 A1
(43) Pub. Date: Nov. 19, 2009

(54) Light bulb cover

(76) Inventor: Charles Ernest Daffin, Tallahassee, FL (US)

Correspondence Address: Charles Ernest Daffin III, 5018 Bradford Ville Road, Tallahassee, FL, 32309, US

(21) Appl. No.: 12/152,358

(22) Filed: May 15, 2008

(51) Int. Cl. F21V 5/08

(52) U.S. Cl. 362/310

(57) ABSTRACT

A way to use common inexpensive light bulbs in recess ceiling light cans. A cover that attaches to the bulb itself and will fill the trim hole for appearence and also reflect light down out of the recess can.

### FIELD OF THE INVENTION

The present invention relates to light bulbs and, more particularly, to a cover for light bulb's

### BACKGROUND OF THE INVENTION

Recess lighting in homes and commercial buildings require a special light bulb. The example here is with a recess ceiling can that requires a indoor flood or spot bulb that has a large enough globe base in order to completely fill the opening space in the recess can it is inserted into. The problem is that these special bulbs are very expensive compared to regular light bulbs. An incandescent recess bulb costs $5 +/−. A fluorescent recess bulb costs $10. Regular incandescent light bulbs cost 50 cents and same fluorescent bulbs cost $2 instead of $10. The regular economical bulbs will fit into the recess can but have a bad appearance because they do not fill out the recess can opening. Also the regular bulb, if inserted into the recess can will not reflect the light down out of the can efficiently.

There needs to be a way to use the inexpensive bulbs in recess light cans.

Not aware of any simple inexpensive solutions

It would be advantageous to provide a way to use the regular inexpensive light bulbs in recess light cans that require the more expensive bulbs.

It would also be advantageous to provide a cover for the inexpensive bulb that would make them look and function just like the more expensive bulbs.

It would further be advantageous to provide a cover that can be reused over and over again.

### SUMMARY OF THE INVENTION

In accordance with the present invention, there is provided a way to use common inexpensive light bulbs in recess ceiling light cans. A cover that attaches to the bulb itself and will fill the trim hole for appearance and also reflect light down out of the recess can.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a plan view of a “light bulb cover”;

FIG. 2 is an elevation view of a light bulbs;

FIG. 3 is an elevation view of a “light bulb cover” to be inserted over bulb and placed into recess can; and

FIG. 4 is an elevation view of a “light bulb cover” on the bulb and in place in a recess can.

For purposes of clarity and brevity, like elements and components will bear the same designations and numbering throughout the Figures.

### DESCRIPTION OF THE PREFERRED EMBODIMENT

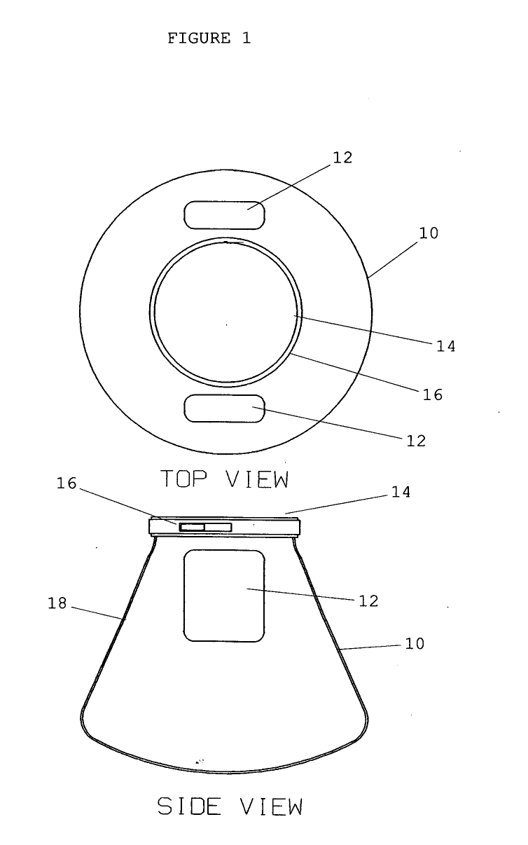

FIG. 1 is a plan view of the “light bulb cover 10”. This is the invention. A clear glass or synthetic material that has the shape of the intended light bulb for a recess can fixture and its recess can ceiling- 28 trim. It has a gripping ring 14 of a fireproof heat resistant griping material that allows the locking attachment 16 ring, camlock, velcro, screw or threaded system to attach the “light bulb cover 10” to a standard light bulb. The cover also has a reflective coating 18 on the sides in order to reflect light down out of the recess can and air holes 12 for ventilation.

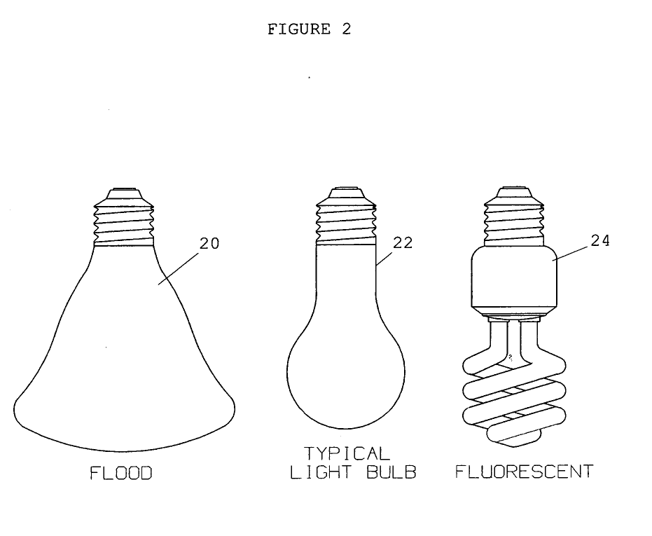

FIG. 2 is an elevation view of light bulbs. This view shows typical light bulbs. The first, on left, is the flood light that is made for use in recess ceiling can 26 fixtures and is very expensive $5-$10. The middle bulb is the everyday typical incandescent bulb 22 that cost 50 cents but is not shaped to be used in a recess can fixture. The light bulb on the right is a typical fluorescent bulb 24 that cost around $2 each but is also not shaped to be used in a recess fixture. Nor will either reflect light down out of the recess can efficiently.

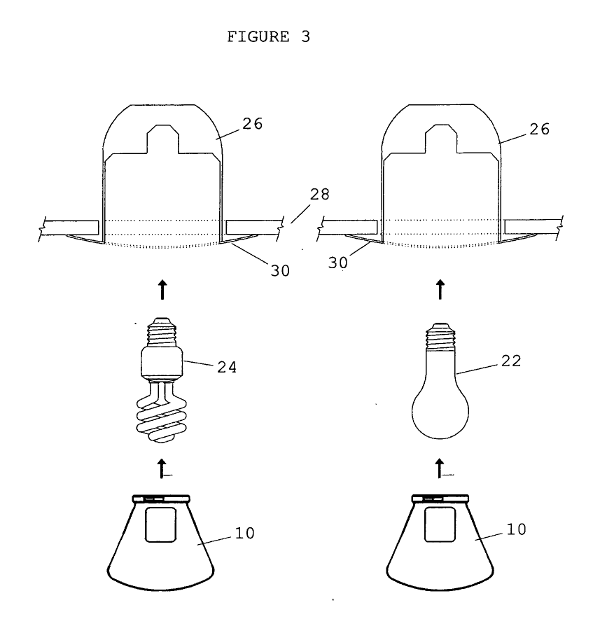

FIG. 3 is an elevation view of the “light bulb cover 10” to be inserted over bulb and placed into recess can. This shows the process of attaching the “light bulb cover 10” to the standard light bulb then installing into a recess rough in can. Note that the “light bulb cover 10” can be reused whenever a light bulb is replaced.

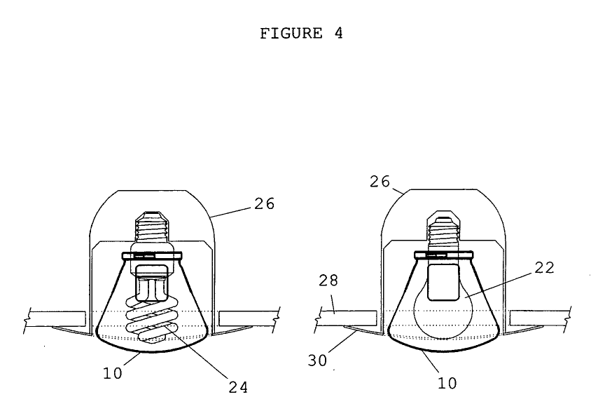

FIG. 4 is an elevation view of the “light bulb cover 10” on a bulb and in place in a recess can.

Thus in summary, it can be seen that what is provided in this invention is a light bulb cover 10 that is both functional, simple, inexpensive and decorative. A cover that is shaped to fit ceiling- 28 recess can's and trim's. That has a simple attachment to any inexpensive, on the market, light bulb. So that such bulbs can be used in recess ceiling can 26 fixtures instead of the much more expensive bulbs that are made for recess light fixtures. The “light bulb cover 10” has the same look and function as the expensive flood bulbs. The “light bulb cover 10” can also be used as a stand alone protective cover for light bulbs if not used in a recess can fixture.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A light bulb cover for changing a light bulb's size, appearance, light reflection and added protection, comprising:
means for covering a typical light bulb so after installing into a ceiling recess can it fits for apperance and reflects light down;
means for let air flow in and out;
means for to grip the light bulb and attach the “light bulb cover to the light bulb;
means for securely lock “light bulb cover” to light bulb, rigidly connected to said means for to grip the light bulb and attach the “light bulb cover to the light bulb, and rigidly connected to said means for covering a typical light bulb so after installing into a ceiling recess can it fits for apperance and reflects light down; and
means for reflect light down.

2. The light bulb cover in accordance with claim 1, wherein said means for covering a typical light bulb so after installing into a ceiling recess can it fits for apperance and reflects light down comprises a light bulb cover light bulb cover.

3. The light bulb cover in accordance with claim 1, wherein said means for let air flow in and out comprises an open holes air holes.

4. The light bulb cover in accordance with claim 1, wherein said means for to grip the light bulb and attach the “light bulb cover to the light bulb comprises a gripping, heat resistance gripping ring.

5. The light bulb cover in accordance with claim 1, wherein said means for securely lock “light bulb cover” to light bulb comprises a fastener locking attachment.

6. The light bulb cover in accordance with claim 1, wherein said means for reflect light down comprises a light reflecting reflective coating.

7. A light bulb cover for changing a light bulb's size, appearance, light reflection and added protection, comprising:
a light bulb cover light bulb cover, for covering a typical light bulb so after installing into a ceiling recess can it fits for apperance and reflects light down;
an open holes air holes, for let air flow in and out;
a gripping, heat resistance gripping ring, for to grip the light bulb and attach the “light bulb cover to the light bulb;
a fastener locking attachment, for securely lock “light bulb cover” to light bulb, rigidly connected to said gripping ring, and rigidly connected to said light bulb cover; and
a light reflecting reflective coating, for reflect light down.

8. A light bulb cover for changing a light bulb's size, appearance, light reflection and added protection, comprising:
a light bulb cover light bulb cover, for covering a typical light bulb so after installing into a ceiling recess can it fits for apperance and reflects light down;
an open holes air holes, for let air flow in and out;
a gripping, heat resistance gripping ring, for to grip the light bulb and attach the “light bulb cover to the light bulb;
a fastener locking attachment, for securely lock “light bulb cover” to light bulb, rigidly connected to said gripping ring, and rigidly connected to said light bulb cover; and
a light reflecting reflective coating, for reflect light down.
